(19) United States
(12) Patent Application Publication
(10) Pub. No.: US 2026/0042694 A1
(43) Pub. Date: Feb. 12, 2026

(54) MOLTEN GLASS DELIVERY APPARATUS

(71) Applicant: CORNING INCORPORATED, CORNING, NY (US)

(72) Inventors: Gilbert De Angelis, Lindley, NY (US); Sandor Matthew Fox, Cohocton, NY (US); Pierre Rene Joseph Laronze, Corning, NY (US); Eric Lee Miller, Corning, NY (US); Brian Michael Palmer, Corning, NY (US); Felix Sylvain Xu, Wenham, MA (US)

(21) Appl. No.: 19/103,088

(22) PCT Filed: Sep. 1, 2023
(86) PCT No.: PCT/US2023/031808

§ 371 Date: Feb. 11, 2025

Related U.S. Application Data
(60) Provisional application No. 63/375,060, filed on Sep. 9, 2022.

(51) Int. Cl. C03B 7/07; C03B 5/167

(52) U.S. Cl. CPC C03B 7/07; C03B 5/167

(57) ABSTRACT

A glass manufacturing apparatus is disclosed including a molten glass delivery apparatus including a lower carriage, an upper rail system supported on the lower carriage and including first and second side upper support rails oriented at an elevation angle α greater than 0 degrees relative to horizontal, and upper carriages supported on the upper rail system. Each upper carriage includes a base plate oriented at an elevation angle β greater than 0 degrees relative to horizontal, a first side upper roller coupled to the base plate and engaged with the first side upper support rail, and a second side upper roller coupled to the base plate and engaged with the second side upper support rail. One upper roller includes a rolling surface including a groove engaged with a tongue of one of the first and second side upper support rails. The other upper roller includes a flat rolling surface.

### CROSS-REFERENCE TO RELATED APPLICATIONS

This application claims the benefit of priority under 35 U.S. C. § 119 of U.S. Provisional Application Ser. No. 63/375060 filed on Sep. 9, 2022, the content of which is relied upon and incorporated herein by reference in its entirety.

### TECHNICAL FIELD

The present specification relates to glass manufacturing apparatuses and, more particularly, to glass manufacturing apparatuses with molten glass delivery apparatuses and molten glass delivery conduits for use therewith.

### BACKGROUND

Glass manufacturing apparatuses can include a variety of discrete components for melting, processing, and forming glass. For example, a typical glass manufacturing apparatus may include, among other components, a melter for melting a batch of glass constituent components to form a molten material precursor (e.g., molten glass), a fining system for removing dissolved gasses from the molten glass, a mixing vessel for homogenizing the molten glass, and a forming apparatus for forming the molten glass into a desired shape (e.g., a ribbon, cylinders, tubes, etc.). The components of the glass manufacturing apparatus may be connected in series through a plurality of delivery conduits through which the molten glass flows from one component to the next. The delivery conduits may be formed from refractory metals, such as platinum, platinum alloys, and the like, to withstand the relatively high temperatures and corrosive nature of the molten glass.

The components of the glass manufacturing apparatus may be subjected to high temperatures for extended periods. Cycling between room temperature conditions and the high temperature operating conditions of the glass manufacturing apparatus may introduce stresses to the components of the glass manufacturing apparatus. Regular and continuous introduction of stresses to the components of the glass manufacturing apparatus may lead to premature failure of the components. Further, increasing the throughput of molten glass through the glass manufacturing apparatus may necessitate the use of higher temperatures to ensure proper flow of the molten glass through the glass manufacturing apparatus. Higher operating temperatures may further increase the stresses introduced in the components of the glass manufacturing apparatus and, in turn, reduce the service life of the components.

Accordingly, a need exists for alternative designs for components of the glass manufacturing apparatuses that mitigate stress on the components and thereby extend the service life of the components.

### SUMMARY

In a first aspect, a glass manufacturing apparatus comprising a molten glass delivery apparatus, the molten glass delivery apparatus comprising: a lower carriage; an upper rail system supported on the lower carriage, the upper rail system comprising a first side upper support rail and a second side upper support rail, the first side upper support rail and the second side upper support rail oriented at an elevation angle α greater than 0 degrees relative to horizontal; and a plurality of upper carriages supported on the upper rail system, each of the plurality of upper carriages comprising: a base plate oriented at an elevation angle β greater than 0 degrees relative to horizontal; a first side upper roller coupled to the base plate and engaged with the first side upper support rail; and a second side upper roller coupled to the base plate and engaged with the second side upper support rail, wherein: one of the first side upper roller and the first side upper support rail comprises a rolling surface including a groove engaged with a tongue of the other of the first side upper roller and the first side upper support rail; or one of the second side upper roller and the second side upper support rail comprises a rolling surface including a groove engaged with a tongue of the other of the first side upper roller and the first side upper support rail.

A second aspect includes the glass manufacturing apparatus of the first aspect, wherein the elevation angle α is equal to the elevation angle β.

A third aspect includes the glass manufacturing apparatus of the first aspect or the second aspect, further comprising a vertical biasing member extending between the lower carriage and the upper rail system and permitting the upper rail system to move in a vertical direction relative to the lower carriage.

A fourth aspect includes the glass manufacturing apparatus of any one of the first aspect through the third aspect, further comprising a lower rail system comprising a first side lower support rail and a second side lower support rail, the lower carriage supported on the lower rail system.

A fifth aspect includes the glass manufacturing apparatus of the fourth aspect, wherein the lower carriage is fixed to the lower rail system.

A sixth aspect includes the glass manufacturing apparatus of the fourth aspect, wherein the lower carriage comprises a first side lower roller and a second side lower roller.

A seventh aspect includes the glass manufacturing apparatus of the sixth aspect, wherein the first side lower roller engages the first side lower support rail and the second side lower roller engages the first side lower support rail.

An eighth aspect includes the glass manufacturing apparatus of the sixth aspect or the seventh aspect, wherein: one of the first side upper roller and the first side upper support rail comprises a rolling surface including a groove engaged with a tongue of the other of the first side upper roller and the first side upper support rail; or one of the second side upper roller and the second side upper support rail comprises a rolling surface including a groove engaged with a tongue of the other of the first side upper roller and the first side upper support rail.

A ninth aspect includes the glass manufacturing apparatus of any one of the first aspect through the eighth aspect, further comprising an expansion assist member coupled to the lower carriage, the expansion assist member applying an expansion assist force to the lower carriage.

A tenth aspect includes the glass manufacturing apparatus of any one of the first aspect through the ninth aspect, further comprising a support frame coupled to the base plate of each upper carriage, the support frame comprising: vertical support members coupled to the base plate with lateral spring elements such that the vertical support members are displaceable in a lateral direction relative to the base plate; and horizontal support members coupled to the vertical support members with vertical spring elements and lateral spring elements such that the horizontal support members are displaceable in a vertical direction relative to the vertical support members and the vertical support members are displaceable in the lateral direction relative to the horizontal support members.

An eleventh aspect includes the glass manufacturing apparatus of any one of the first aspect through the tenth aspect, further comprising: a lower locating feature provided on the lower carriage; and an upper locating feature provided on the upper rail system, wherein, when the upper rail system is supported on the lower carriage, the lower locating feature aligns with the upper locating feature in a vertical direction relative to each upper carriage.

A twelfth aspect includes the glass manufacturing apparatus of any one of the first aspect through the eleventh aspect, wherein each upper carriage of the plurality of upper carriages further comprises a molten glass delivery conduit assembly supported on the upper carriage, the molten glass delivery conduit assembly comprising: a cradle assembly comprising an upper cradle block formed from refractory ceramic material and a lower cradle block formed from refractory ceramic material; a tube assembly positioned in the cradle assembly and extending in a longitudinal direction of the molten glass delivery conduit assembly, the tube assembly comprising an upper tube portion formed from refractory ceramic material and a lower tube portion formed from refractory ceramic material; and a delivery conduit positioned in the tube assembly and extending in the longitudinal direction, the delivery conduit formed from refractory metal.

A thirteenth aspect includes the glass manufacturing apparatus of the twelfth aspect, wherein the upper cradle block and the lower cradle block of a first upper carriage of the plurality of upper carriages interlocks with the upper cradle block and the lower cradle block of a second upper carriage of the plurality of upper carriages, the first upper carriage being adjacent the second upper carriage.

A fourteenth aspect includes the glass manufacturing apparatus of the thirteenth aspect, wherein: the upper cradle block and the lower cradle block of the first upper carriage each comprises a projection extending in the longitudinal direction of the molten glass delivery conduit assembly; the upper cradle block and the lower cradle block of the second upper carriage each comprises a groove formed in the longitudinal direction of the molten glass delivery conduit assembly; and the projection of the upper cradle block and the lower cradle block of the first upper carriage is engaged with the groove formed in the upper cradle block and the lower cradle block of the second upper carriage.

A fifteenth aspect includes the glass manufacturing apparatus of any one of the twelfth aspect through the fourteenth aspect, further comprising a flange coupled to the delivery conduit.

A sixteenth aspect includes the glass manufacturing apparatus of the fifteenth aspect, further comprising a translatable support coupled to the flange and a spring element applying a force to the flange in a vertical direction.

In a seventeenth aspect, a glass manufacturing apparatus comprising a plurality of upper carriages, each upper carriage of the plurality of upper carriages comprising a molten glass delivery conduit assembly comprising: a cradle assembly comprising an upper cradle block formed from refractory ceramic material and a lower cradle block formed from refractory ceramic material; a tube assembly positioned in the cradle assembly and extending in a longitudinal direction of the molten glass delivery conduit assembly, the tube assembly comprising an upper tube portion formed from refractory ceramic material and a lower tube portion formed from refractory ceramic material; and a delivery conduit positioned in the tube assembly and extending in the longitudinal direction, the delivery conduit formed from refractory metal, wherein the upper cradle block and the lower cradle block of a first upper carriage of the plurality of upper carriages interlocks with the upper cradle block and the lower cradle block of a second upper carriage of the plurality of upper carriages, the first upper carriage being adjacent the second upper carriage.

An eighteenth aspect includes the glass manufacturing apparatus of the seventeenth aspect, wherein: the upper cradle block and the lower cradle block of the first upper carriage each comprises a projection extending in the longitudinal direction of the molten glass delivery conduit assembly; the upper cradle block and the lower cradle block of the second upper carriage each comprises a groove formed in the longitudinal direction of the molten glass delivery conduit assembly; and the projection of the upper cradle block and the lower cradle block of the first upper carriage is engaged with the groove formed in the upper cradle block and the lower cradle block of the second upper carriage.

A nineteenth aspect includes the glass manufacturing apparatus of the seventeenth aspect or the eighteenth aspect, further comprising a refractory block positioned around the cradle assembly, the refractory block formed from refractory ceramic material.

A twentieth aspect includes the glass manufacturing apparatus of any one of the eighteenth aspect or the nineteenth aspect, further comprising a flange coupled to the delivery conduit.

A twenty-first aspect includes the glass manufacturing apparatus of the twentieth aspect, wherein the projection of the upper cradle block and the lower cradle block of the first upper carriage is formed at the flange.

A twenty-second aspect includes the glass manufacturing apparatus of any one of the seventeenth aspect through the twenty-first aspect, further comprising: a lower carriage; and an upper rail system supported on the lower carriage, the upper rail system comprising a first side upper support rail and a second side upper support rail, the first side upper support rail and the second side upper support rail oriented at an elevation angle α greater than 0 degrees relative to horizontal, wherein each upper carriage of the plurality of upper carriages comprises: a base plate oriented at an elevation angle β greater than 0 degrees relative to horizontal; a first side upper roller coupled to the base plate and engaged with the first side upper support rail; and a second side upper roller coupled to the base plate and engaged with the second side upper support rail.

A twenty-third aspect includes the glass manufacturing apparatus of the twenty-second aspect, wherein: one of the first side upper roller and the first side upper support rail comprises a rolling surface including a groove engaged with a tongue of the other of the first side upper roller and the first side upper support rail; or one of the second side upper roller and the second side upper support rail comprises a rolling surface including a groove engaged with a tongue of the other of the first side upper roller and the first side upper support rail.

Additional features and advantages of the modular molten glass delivery apparatuses and glass manufacturing apparatuses comprising the same described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a glass manufacturing apparatus according to one or more embodiments shown and described herein;

FIG. 2 schematically depicts side view of a molten glass delivery apparatus of the glass manufacturing apparatus of FIG. 1 comprising a plurality of upper carriages mounted on an upper rail system, a lower carriage, and a lower rail system, according to one or more embodiments shown and described herein;

FIG. 3 schematically depicts a side view of an upper carriage of the molten glass delivery apparatus of FIG. 2 mounted on the upper rail system, the lower carriage, and the lower rail system, according to one or more embodiments shown and described herein;

FIG. 4 schematically depicts a cross-section view of the molten glass delivery apparatus of FIG. 1 taken along line 4-4 of FIG. 3, according to one or more embodiments shown and described herein;

FIG. 5A schematically depicts a perspective view of a first side lower carriage roller of the molten glass delivery apparatus of FIG. 2, according to one or more embodiments shown and described herein;

FIG. 5B schematically depicts a perspective view of a second side lower carriage roller of the molten glass delivery apparatus of FIG. 2, according to one or more embodiments shown and described herein;

FIG. 6 schematically depicts a cross-section view of the molten glass delivery apparatus of FIG. 2 including a molten glass delivery conduit assembly, according to one or more embodiments shown and described herein;

FIG. 7 schematically depicts a side view of another embodiment of a molten glass delivery apparatus comprising a plurality of upper carriages mounted on an upper rail system and a lower carriage, according to one or more embodiments shown and described herein;

FIG. 8A schematically depicts a vertical cross-section view of the molten glass delivery conduit assembly of the molten glass delivery apparatus of FIG. 6, according to one or more embodiments shown and described herein;

FIG. 8B schematically depicts an exploded view of a portion of the molten glass delivery conduit assembly of FIG. 8A, according to one or more embodiments shown and described herein;

FIG. 8C schematically depicts a vertical cross-section view of the molten glass delivery conduit assembly of FIG. 8A with a flange affixed thereto, according to one or more embodiments shown and described herein;

FIG. 9 schematically depicts a cross-section view of a pair of adjacent molten glass delivery conduit assemblies, according to one or more embodiments shown and described herein;

FIG. 10 schematically depicts a side view of a glass seal formed between flanges of adjacent upper carriages of a molten glass delivery apparatus, according to one or more embodiments shown and described herein;

FIG. 11 schematically depicts a cross-section view of the molten glass delivery apparatus of FIG. 2 comprising an exterior support frame, according to one or more embodiments shown and described herein;

FIG. 12 schematically depicts a front view of a translatable support, according to one or more embodiments shown and described herein; and

FIG. 13 schematically depicts a perspective view of an overhead support structure for supporting delivery cables coupled to a flange, according to one or more embodiments shown and described herein.

### DETAILED DESCRIPTION

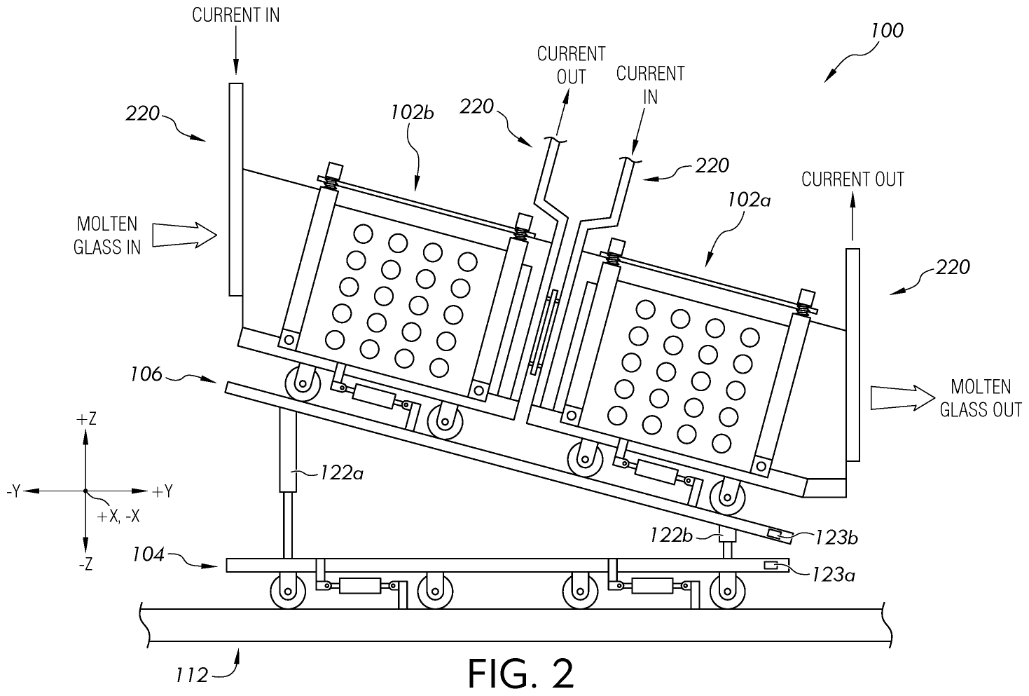

Reference will now be made in detail to embodiments of molten glass delivery apparatuses described herein and glass manufacturing apparatuses comprising the same, examples of which are illustrated in the accompanying drawings. Whenever possible, the same reference numerals will be used throughout the drawings to refer to the same or like parts. One embodiment of a molten glass delivery apparatus is schematically depicted in FIG. 2. The molten glass delivery apparatus may comprise a lower carriage comprising a plurality of lower carriage rollers, an upper rail system supported on the lower carriage, and a plurality of upper carriages. The upper rail system may comprise a pair of upper support rails oriented at an elevation angle α greater than 0 degrees relative to horizontal. Each upper carriage may comprise a base plate oriented at an elevation angle β greater than 0 degrees relative to horizontal and a plurality of upper carriage rollers coupled to the base plate and engaged with the pair of upper support rails of the upper rail system to facilitate translation of the upper carriages on the upper rail system. A support frame may be coupled to the base plate and a molten glass delivery conduit assembly may be supported on the base plate within the support frame. Various embodiments of molten glass delivery apparatuses, molten glass delivery conduits for use therewith, and glass manufacturing apparatuses comprising the same will be described in further detail herein with specific reference to the appended drawings.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein-for example up, down, right, left, front, back, top, bottom-are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

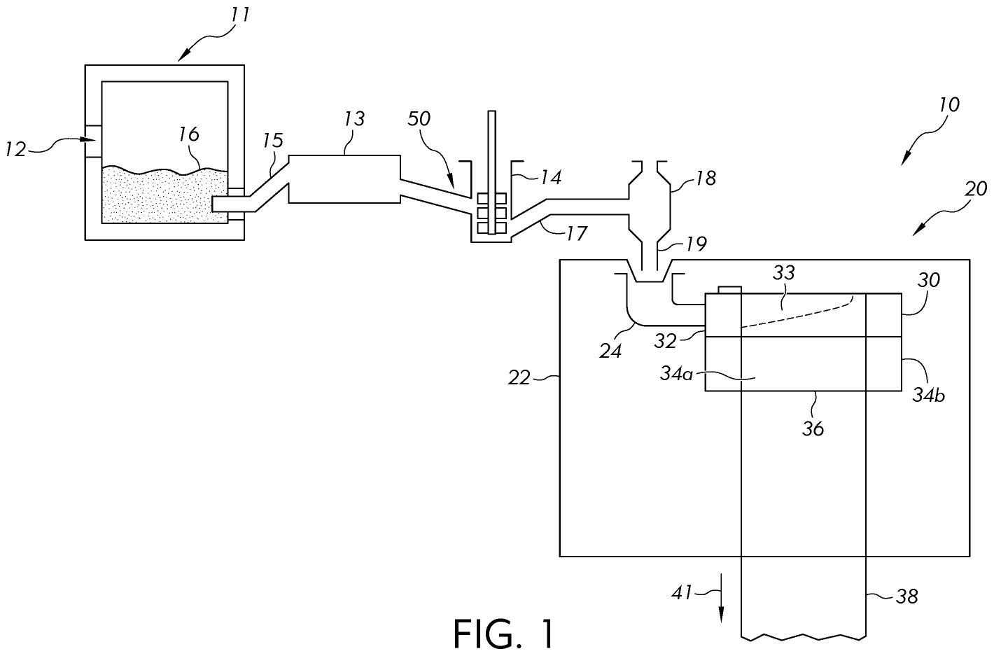

Referring to FIG. 1 by way of example, an embodiment of a glass manufacturing apparatus 10 for forming glass articles from molten glass is schematically depicted. The glass manufacturing apparatus 10 may include a melter 11, a fining system 13, a mixing vessel 14, a delivery vessel 18, and a forming apparatus 20. Glass batch materials are introduced into the melter 11 through a batch inlet port 12. The batch materials are melted in the melter 11 to form molten glass 16. The melter 11 is fluidly coupled to the fining system 13 with a connecting tube 15. The molten glass 16 flows from the melter 11, through the connecting tube 15, and into the fining system 13.

The fining system 13 may comprise a high temperature processing area that receives the molten glass 16 from the melter 11. While the molten glass 16 is resident in the fining system 13, dissolved gasses and/or bubbles are removed from the molten glass 16. The fining system 13 may be fluidly coupled to the mixing vessel 14 by a connecting tube 50. That is, molten glass flowing from the fining system 13 to the mixing vessel 14 may flow through the connecting tube 50. As the molten glass 16 passes through the mixing vessel 14, the molten glass 16 may be stirred to homogenize the molten glass. The mixing vessel 14 may be, in turn, fluidly coupled to the delivery vessel 18 by a connecting tube 17 such that molten glass flowing from the mixing vessel 14 to the delivery vessel 18 flows through the connecting tube 17.

The delivery vessel 18 supplies the molten glass 16 through a downcomer 19 into the forming apparatus 20. The forming apparatus 20 may be, for example and without limitation, a fusion draw machine or another forming apparatus for forming molten glass into a glass article such as ribbons, tubes, boules, or the like. In the embodiment depicted in FIG. 1 the forming apparatus 20 is a fusion draw machine that comprises an enclosure 22 in which an inlet 24 and a forming vessel 30 are positioned. The molten glass 16 from the downcomer 19 flows into the inlet 24, which leads to the forming vessel 30. The forming vessel 30 includes an opening 32 that receives the molten glass 16. The molten glass 16 may flow into a trough 33 and then overflows and runs down two converging sides 34a and 34b of the forming vessel 30 before fusing together at a root 36 of the forming vessel 30, where the two sides join, before being contacted and drawn in a downstream direction 41 to form a continuous glass ribbon 38.

While FIG. 1 schematically depicts a glass manufacturing apparatus 10 for forming glass ribbon using a fusion draw machine, other processes may be used to form the glass ribbon, including, without limitation, float glass processes, slot draw processes or the like. Further, while the glass manufacturing apparatus 10 is depicted as being used for forming glass ribbon, other glass manufacturing apparatuses may be used for forming glass stock material other than glass sheets including, without limitation, glass tubes, glass cylinders, boules, and the like.

The glass manufacturing apparatus 10 may be constructed at room temperature and thereafter operated at elevated temperatures. Heating the components of the glass manufacturing apparatus 10 to operating temperatures increases the dimensional size of the components according to their respective coefficients of thermal expansion. For example, the connecting tubes 15, 17, 50 may be formed from refractory metals and may thermally expand upon heating. The thermal expansion introduces stress into the connecting tubes 15, 17, 50. Additional stress may be imparted to the connecting tubes 15, 17, 50 if the thermal expansion of the connecting tubes 15, 17, 50 is constrained by adjacent components in the glass manufacturing apparatus 10. For example, connecting tube 50 is positioned between and coupled to the fining system 13 and the mixing vessel 14, each of which may also thermally expand upon heating. The thermal expansion of the fining system 13 and the mixing vessel 14 may constrain or inhibit the thermal expansion of the connecting tube 50, thereby introducing additional stress in the connecting tube 50. Because of the high operating temperatures of the refractory metal, even low levels of stress that are imparted to the refractory metal of the connecting tubes 15, 17, 50 may cause creep in the refractory metal, thereby reducing the service life of the connecting tubes 15, 17, 50 and increasing the risk of failure. Repair and/or replacement of the connecting tubes 15, 17, 50 is expensive and time consuming and may decrease production yields as the glass manufacturing apparatus 10 may be shut down for extended periods of time to facilitate repair and/or replacement.

Disclosed herein are molten glass delivery apparatuses, molten glass delivery conduits for use therewith, and glass manufacturing apparatuses comprising the same. The molten glass delivery apparatus may be used, for example, as connecting tubes between various components of the glass manufacturing apparatus, such as connecting tubes 15, 17, 50. The molten glass delivery apparatus is constructed to reduce or mitigate stresses introduced in the refractory metal of the molten glass delivery apparatuses, thereby prolonging the service life of the molten glass delivery apparatuses, increasing production yields, and reducing the operating and maintenance costs of the glass manufacturing apparatuses.

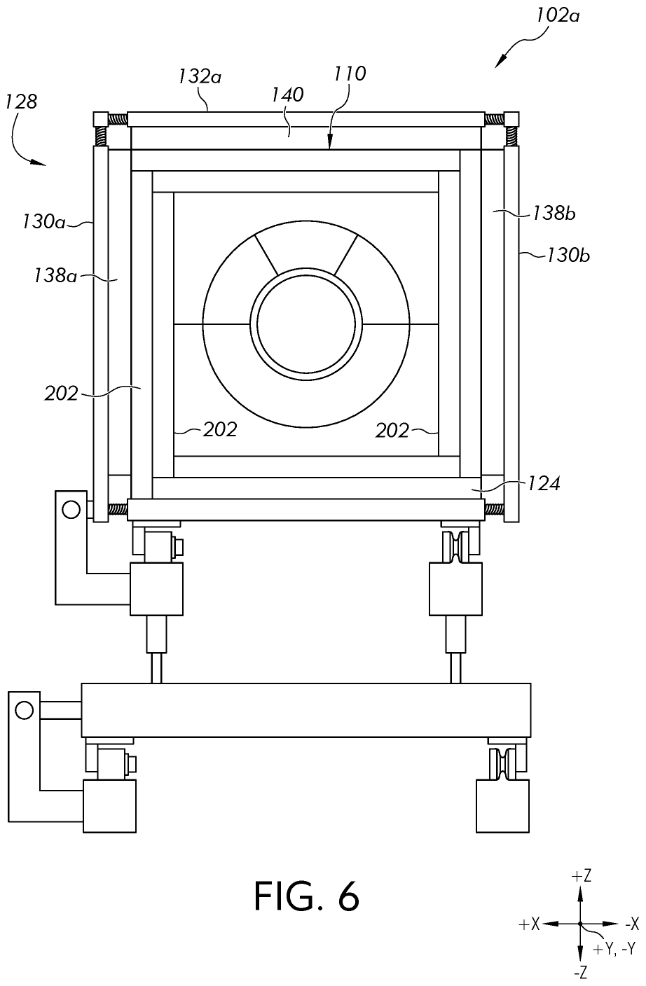

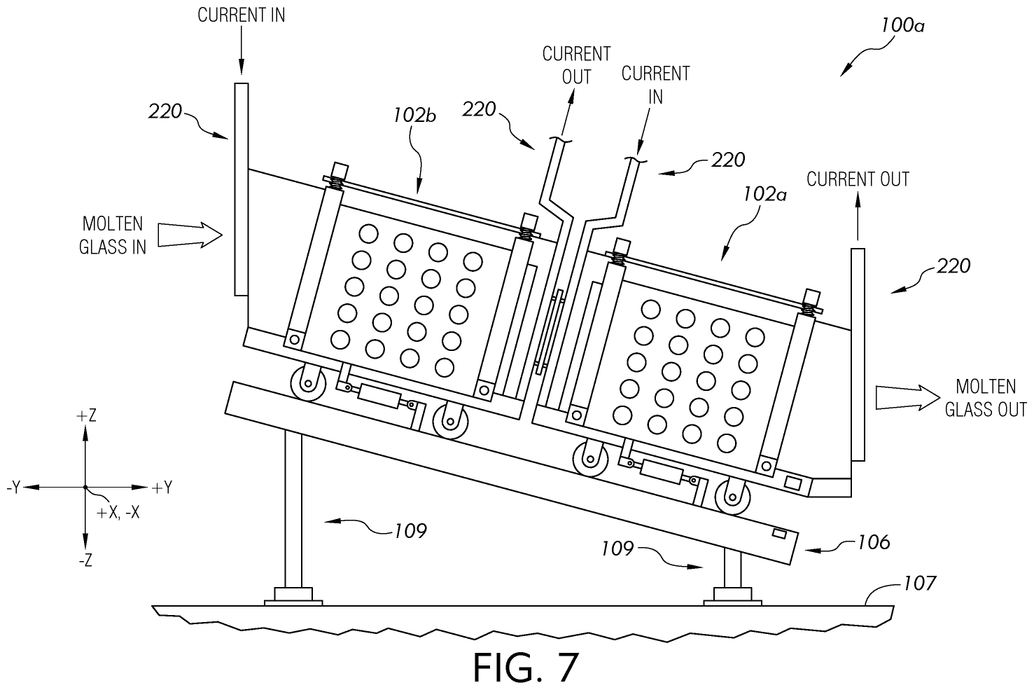

Referring now to FIG. 2, an example of a molten glass delivery apparatus 100 is schematically depicted. In the embodiment depicted in FIG. 2, the molten glass delivery apparatus is arranged to couple the fining system 13 (FIG. 1) to the mixing vessel 14 (FIG. 1) in the glass manufacturing apparatus 10 (FIG. 1) in place of connecting tube 50. However, the molten glass delivery apparatus 100 may be used to couple other components of the glass manufacturing apparatus 10, including without limitation, the melter 11 and the fining system 13 (i.e., in place of connecting tube 15), the mixing vessel 14 and the delivery vessel 18 (i.e., in place of connecting tube 17), etc. The molten glass delivery apparatus 100 may include a plurality of upper carriages. In the embodiment depicted in FIG. 2, the molten glass delivery apparatus 100 includes two upper carriages (upper carriage 102a and upper carriage 102b). However, it should be understood that the molten glass delivery apparatus 100 may include greater than two upper carriages. The molten glass delivery apparatus 100 may further comprise a lower carriage 104, an upper rail system 106, and a molten glass delivery conduit assembly 110 (schematically depicted in FIGS. 6-7C). In embodiments, a lower locating feature 123a is provided on the lower carriage 104 and an upper locating feature 123b is provided on the upper rail system 106. When the upper rail system 106 is supported on the lower carriage 104, the lower locating feature 123a aligns with the upper locating feature 123b in a vertical direction relative to the upper carriage. In embodiments, the lower locating feature 123a and the upper locating feature 123b may be any suitable structure such as, for example, a datum, machine pad, or the like, to provide for better alignment of components during fabrication and assembly. The locating features 123a, 123b provide precise reference points to locate process centerline during fabrication and field assembly, as well as accurate positioning of rail systems of the molten glass delivery system 100.

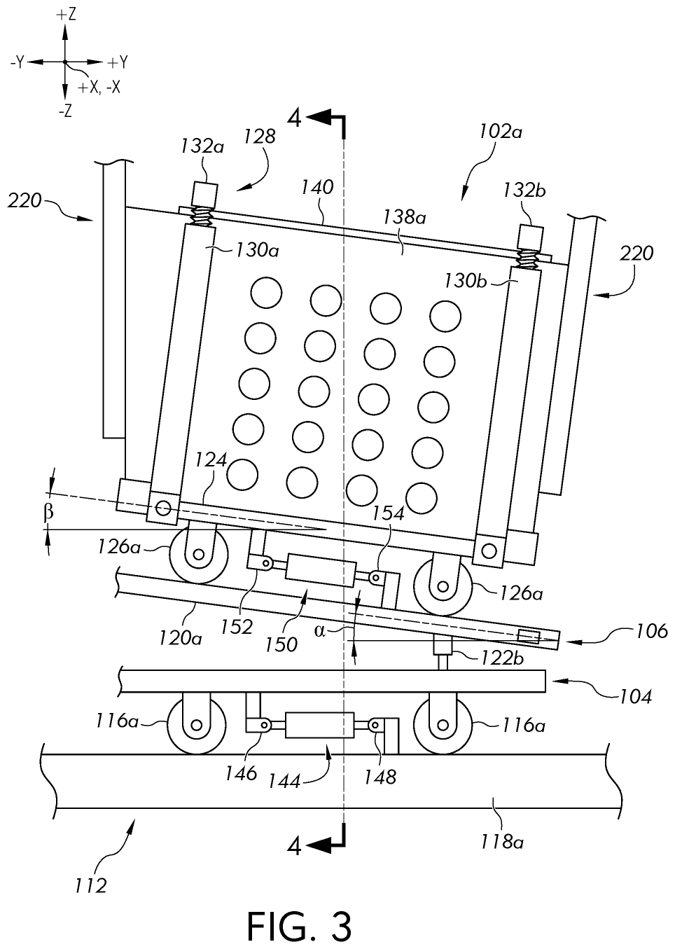

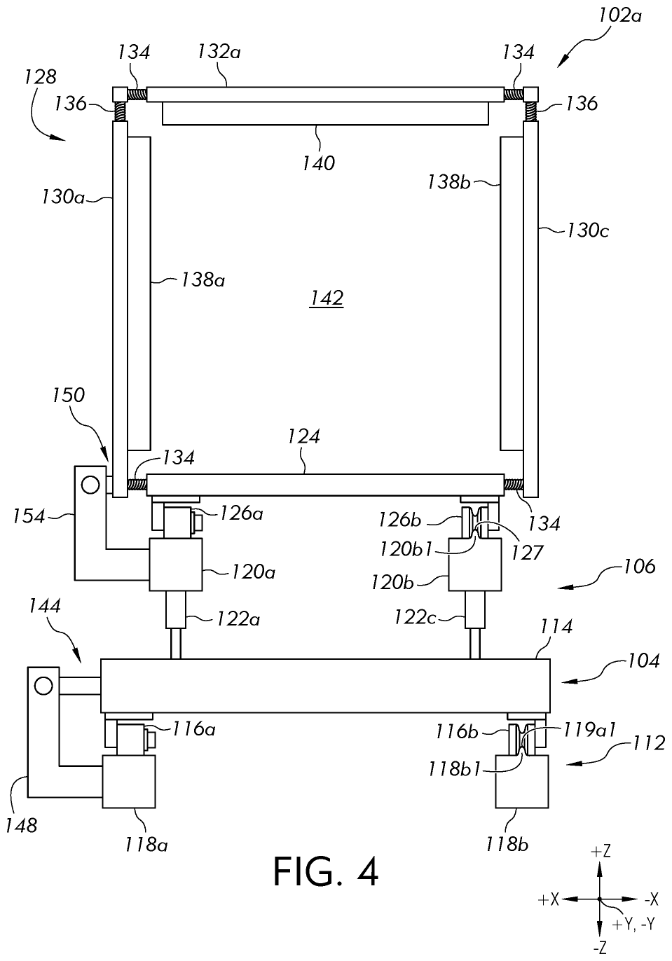

Referring now to FIGS. 3 and 4, a partial view of the molten glass delivery apparatus 100 is schematically depicted illustrating one upper carriage (upper carriage 102a) mounted atop the lower carriage 104 and the upper rail system 106 (FIG. 3), and in vertical cross-section (FIG. 4). Specifically, FIG. 4 depicts a cross-section of the molten glass delivery apparatus 100 in the X-Z plane of the coordinate axes depicted in the figures. For ease of description, FIG. 4 depicts the upper carriage 102a without the molten glass delivery conduit assembly 110 (described in further detail herein). While specific reference is made herein to the components and structure of the upper carriage 102a, it should be understood that the upper carriage 102b includes the same components as the upper carriage 102a and is similarly constructed.

As depicted in FIGS. 3 and 4, the lower carriage 104 may comprise a lower carriage frame 114 and a plurality of lower carriage rollers (first side lower carriage rollers 116a and second side lower carriage rollers 116b) coupled to the lower carriage frame 114. In embodiments, the molten glass delivery apparatus 100 may further comprise a lower rail system 112. The lower rail system 112 may comprise a pair of side lower support rails (first side lower support rail 118a and second side lower support rail 118b). The side lower support rails 118a, 118b may be parallel with one another and extend in a longitudinal direction (i.e., the +/−Y direction of the coordinate axes depicted in the figures) of the molten glass delivery apparatus 100. The side lower support rails 118a, 118b may have a substantially horizontal orientation (i.e., the side lower support rails 118a, 118b are positioned in a plane parallel to the X-Y plane of the coordinate axes depicted in the figures). In embodiments, the plurality of lower carriage rollers 116a, 116b may each be engaged with one of the side lower support rails 118a, 118b to facilitate translation of the lower carriage frame 114 (and hence the lower carriage 104) on the lower rail system 112 in the +/−Y direction of the coordinate axes depicted in the figures. For example, the first side lower carriage roller 116a is engaged with the first side lower support rail 118a, and the second side lower carriage roller 116b is engaged with the second side lower support rail 118b. In the embodiments described herein, the lower carriage frame 114 and the side lower support rails 118a, 118b may be formed from a load bearing material such as, for example and without limitation, structural steel or a similar load bearing material.

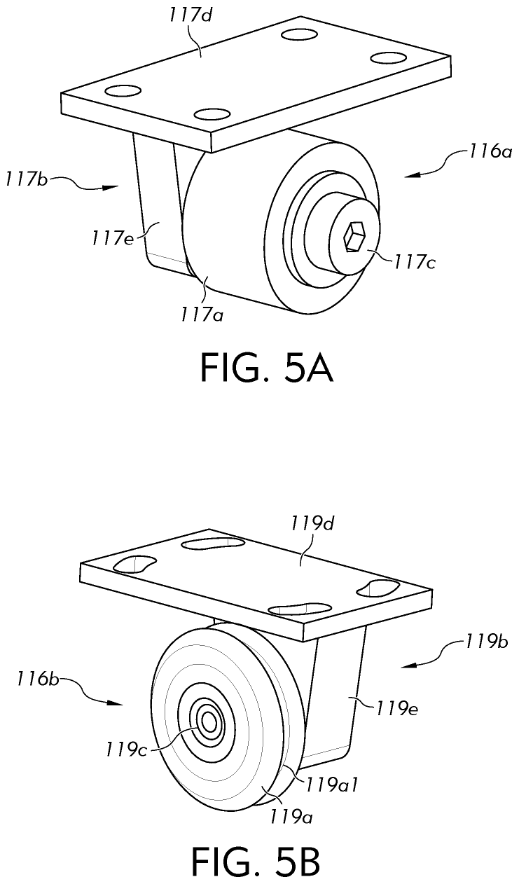

Referring to FIG. 5A, the first side lower carriage roller 116a is depicted. The first side lower carriage roller 116a comprises a rolling surface 117a that contacts an upper surface of the first side lower support rail 118a (FIG. 4). In embodiments, the rolling surface 117a of the first side lower carriage roller 116a is a flat rolling surface, which mates with the upper surface of the first side lower support rail 118a, which is also flat to correspond to the rolling surface 117a. Thus, the first side lower carriage roller 116a is translatable in the +/−X direction of the coordinate axes depicted in the figures. The first side lower carriage roller 116a is rotatably mounted to a first side lower carriage roller coupling 117b by a fastener 117c extending through the first side lower carriage roller 116a. The first side lower carriage roller coupling 117b couples the first side lower carriage roller 116a to the lower carriage frame 114. In embodiments, the first side lower carriage roller coupling 117b includes an upper coupling member 117d mounted to a lower surface of the lower carriage frame 114 and an intermediate coupling member 117e extending between the upper coupling member 117d and the first side lower carriage roller 116a. The fastener 117c extends through the first side lower carriage roller 116a and is connected to the intermediate coupling member 117e to rotatably couple the first side lower carriage roller 116a to the intermediate coupling member 117e.

Referring to FIG. 5B, the second side lower carriage roller 116b is depicted. The second side lower carriage roller 116b comprises a rolling surface 119a that contacts an upper surface of the second side lower support rail 118b (FIG. 4). In embodiments, the rolling surface 119a of the second side lower carriage roller 116b includes a groove 119a1, which mates with a tongue 118b1 formed at an upper surface of the second side lower support rail 118b, which corresponds to the groove 119a1 formed in the rolling surface 119a of the second side lower carriage roller 116b. The second side lower carriage roller 116b is rotatably mounted to a second side lower carriage roller coupling 119b by a fastener 119c extending through the second side lower carriage roller 116b. The second side lower carriage roller coupling 119b couples the second side lower carriage roller 116b to the lower carriage frame 114. In embodiments, the second side lower carriage roller coupling 119b includes an upper coupling member 119d mounted to a lower surface of the lower carriage frame 114 and an intermediate coupling member 119e extending between the upper coupling member 119d and the second side lower carriage roller 116b. The fastener 119c extends through the second side lower carriage roller 116b and is connected to the intermediate coupling member 119e to rotatably couple the second side lower carriage roller 116b to the intermediate coupling member 119e. The engagement between the tongue 118b1 and the groove 119b1 reduces misalignment between the lower carriage 104 and the side lower support rails 118a, 118b and improves ease of motion. The engagement between the tongue 118b1 and the groove 119b1 also permits shifting of the lower carriage 104 relative to the side lower support rails 118a, 118b during expansion of the lower carriage 104 in a lateral direction of the molten glass delivery conduit assembly 110 (i.e., in the +/−X directions of the coordinate axes depicted in the figures).

Although the first side lower carriage roller 116a is depicted as comprising the flat rolling surface 117a, which engages the flat upper surface of the first side lower support rail 118a, and the second side lower carriage roller 116b is depicted as comprising the groove 119a1, which engages the tongue 118b1 on the second side lower support rail 118b, it should be appreciated that the present disclosure is not limited to that specific embodiment. For example, in embodiments, the first side lower carriage roller 116a may comprise a groove formed therein for engaging a tongue provided on the first side lower support rail 118a, and the second side lower carriage roller 116b may comprise a flat rolling surface for engaging a flat upper surface of the second side lower support rail 118b. In addition, it should be appreciated that, in embodiments, each of a plurality of first side lower carriage rollers 116a comprise a flat rolling surface for engaging a flat upper surface of the first side lower support rail 118a, and each of a plurality of second side lower carriage rollers 116b comprise a groove formed therein for engaging a respective tongue provided on the second side lower support rail 118b. Alternatively, in other embodiments, each of a plurality of first side lower carriage rollers 116a comprise a groove formed therein for engaging a respective tongue provided on the first side lower support rail 118a, and each of a plurality of second side lower carriage rollers 116b comprise a flat rolling surface for engaging a flat upper surface of the second side lower support rail 118b. Accordingly, in embodiments, either the first side lower carriage rollers 116a or the second side lower carriage rollers 116b comprises a flat rolling surface for engaging a flat upper surface of either the first side lower support rail 118a or the second side lower support rail 118b while the other of the first side lower carriage rollers 116a or the second side lower carriage rollers 116b comprises a groove for engaging the other of the first side lower support rail 118a or the second side lower support rail 118b. Although it is described herein as the grooves being formed in the first side lower carriage rollers 116 or the second side lower carriage rollers 116b, and the tongue provided on the first side lower support rail 118a or the second side lower support rail 118b, it should be appreciated that the reverse may be true. For example, in embodiments, the groove may be formed the first side lower support rail 118a or the second side lower support rail 118b, and the tongue may be formed in the first side lower carriage rollers 116 or the second side lower carriage rollers 116b for engaging the groove. Although rolling surfaces described herein may be referred to as flat, the rolling surfaces may have a minimal curvature such that the rolling surfaces are at least substantially flat.

Referring again to FIGS. 3 and 4, the molten glass delivery apparatus 100 may further comprise an upper rail system 106. The upper rail system 106 may be supported on the lower carriage frame 114 of the lower carriage 104. The upper rail system 106 may comprise a pair of upper support rails (first side upper support rail 120a and second side upper support rail 120b). The side upper support rails 120a, 120b may be parallel with one another and oriented at an elevation angle α relative to horizontal (i.e., relative to the X-Y plane of the coordinate axes depicted in the figures). In the embodiments described herein, the elevation angle α may be greater than 0 degrees. In embodiments, the elevation angle a may be greater than 0 degrees and less than 90 degrees or even greater than 0 degrees and less than or equal to 45 degrees. In some embodiments, the elevation angle a may be less than 0 degrees and greater than −90 degrees or even less than 0 degrees and greater than or equal to −45 degrees. By providing the elevation angle α, it ensures that the molten material flowing through the upper carriages 102 flows toward the mixing vessel 14 (FIG. 1). In the embodiment of the molten glass delivery apparatus 100 depicted in FIGS. 3 and 4, a spacing between the side upper support rails 120a, 120b and the lower carriage frame 114 decreases in the +Y direction of the coordinate axes depicted in the figures due to the elevation angle α. The side upper support rails 120a, 120b may be supported on the lower carriage frame 114 of the lower carriage 104 with at least two vertical biasing members (vertical biasing members 122a, 122b, 122c depicted in FIGS. 2-4). As depicted in FIG. 2, the vertical biasing member 122a is located in the −Y direction of the coordinate axes depicted in the figures relative to vertical biasing member 122b. In addition, as depicted in FIG. 4, the vertical biasing members 122a, 122c are located in a corresponding location along the Y-axis and mounted to opposite side upper support rails 120a, 120b. The difference in the height between the vertical biasing members 122a, 122c and vertical biasing member 122b may determine the elevation angle α of the side upper support rails 120a, 120b relative to horizontal. Accordingly, in the embodiment of the molten glass delivery apparatus 100 depicted in FIGS. 2-4, the height of the vertical biasing members 122a, 122c may be greater than the height of the vertical biasing member 122b. Like the side lower support rails 118a, 118b and the lower carriage frame 114, the side upper support rails 120a, 120b may be formed from a load bearing material such as, for example and without limitation, structural steel or a similar load bearing material. In the embodiments described herein, the vertical biasing members 122a, 122b, 122c may be coupled to the lower carriage frame 114 and the side upper support rails 120a, 120b by welding and/or mechanical fasteners. In embodiments, the vertical biasing members 122a, 122b, 122c may be, for example and without limitation, compression springs, disc springs, spring bolts, and/or combinations thereof. In embodiments, the vertical biasing members 122a, 122b, 122c enable adjustment of the distance between the lower carriage frame 114 and the side upper support rails 120a, 120b and the elevation angle α. In addition, the vertical biasing members 122a, 122b, 122c allow the side upper support rails 120a, 120b to adjust in vertical position to account for vertical expansion of the fining system 13 and/or the mixing vessel 14 connected to the connecting tube 50. That is, as the fining system 13 and/or the mixing vessel 14 contracts along the vertical direction, the vertical biasing members 122a, 122b, 122c allow the upper carriages 102 and the upper rail system 106 to accommodate the expansion and contraction and avoid stress on the molten glass delivery conduit assembly 110.

In the embodiments described herein, each upper carriage 102a, 102b may be supported on the lower carriage 104. Specifically, the upper carriages 102a, 102b may each comprise a base plate 124 and a plurality of upper carriage rollers (first side upper carriage rollers 126a and second side upper carriage rollers 126b depicted in FIGS. 3 and 4) coupled to the base plate 124. In embodiments, the plurality of upper carriage rollers 126a, 126b may each be engaged with one of the side upper support rails 120a, 120b to facilitate translation of the base plate 124 (and hence the upper carriage 102a) on the upper rail system 106.

It should be appreciated that the first side upper carriage rollers 126a and the second side upper carriage rollers 126b have the same structure as the first side lower carriage rollers 116a and the second side lower carriage rollers 116b, respectively. For example, in embodiments in which the second side lower carriage rollers 116b include the groove 119a1, the second side upper carriage rollers 126b comprise a groove 127 which engages a tongue 120b1 provided at an upper surface of the second side upper support rail 120b. Similarly, in embodiments in which the first side lower carriage rollers 116a include the flat rolling surface 117a, the first side upper carriage rollers 126a also include a similar flat rolling surface. As such, it should be appreciated that the structure of the first side lower carriage rollers 116a have the same structure as the first side upper carriage rollers 126a, and the second side lower carriage rollers 116b have the same structure as the second side upper carriage rollers 126b. This permits for expansion of the upper carriage 102a in the vertical direction.

More specifically, the tongue and groove engagement on only one side of the upper carriages 102, such as on the first side upper carriage rollers 126a and the first side upper support rail 120a, or the second side upper carriage rollers 126b and the second side upper support rail 120b, allows for the lateral displacement of the upper carriage 102a in the lateral direction, but maintains the upper carriages 102 on the upper rail system 106. Similarly, the tongue and groove engagement on only one side, and the same side, of the upper carriages 102, such as on the first side lower carriage rollers 116a and the first side lower support rail 118a, or the second side lower carriage rollers 116b and the second side lower support rail 118b, allows for the lateral displacement of the lower carriage 104 in the lateral direction, but maintains the lower carriage 104 on the lower rail system 112.

The base plate 124 of the upper carriage 102a may be oriented at an elevation angle β relative to horizontal (i.e., relative to the X-Y plane of the coordinate axes depicted in the figures). In the embodiments described herein, the elevation angle β may be greater than 0 degrees. In embodiments, the elevation angle β may be greater than 0 degrees and less than 90 degrees or even greater than 0 degrees and less than or equal to 45 degrees. In embodiments, the elevation angle β may be less than 0 degrees and greater than −90 degrees or even less than 0 degrees and greater than or equal to −45 degrees. Similar to the rationale for providing the elevation angle α, elevation angle β ensures that the molten material flowing through the upper carriages 102 flows toward the mixing vessel 14 (FIG. 1). In embodiments, the elevation angle β may be equal to the elevation angle α. Due to the angular orientation of the base plate 124 of the upper carriage 102a and the angular orientation of the side upper support rails 120a, 120b, the primary vector component of the translational motion of the upper carriage 102a on the side upper support rails 120a, 120b may be parallel to the side lower support rails 118a, 118b and, hence, parallel to the +/−Y direction of the coordinate axes depicted in the figures. In the embodiments described herein, the base plate 124 of the upper carriage 102a may be formed from a load bearing material such as, for example and without limitation, structural steel or a similar load bearing material.

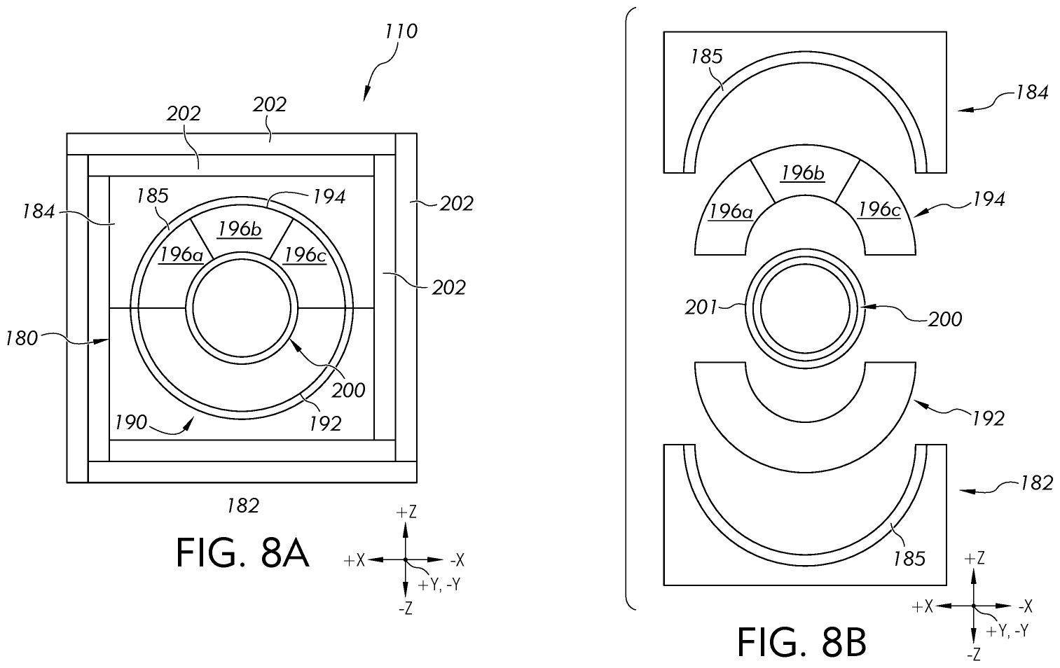

Still referring to FIGS. 3 and 4, the upper carriage 102a is depicted and described herein in more detail. As noted above, while specific reference is made herein to the components and structure of the upper carriage 102a, it should be understood that the upper carriage 102b includes the same components as upper carriage 102a and is similarly constructed. The upper carriage 102a may further comprise a support frame 128 coupled to the base plate 124. The support frame 128 supports and reinforces the molten glass delivery conduit assembly 110 (depicted in FIGS. 6 and 8A-8C) positioned within the volume 142 enclosed by the support frame 128 and the base plate 124. In embodiments, the support frame 128 may also be constructed to accommodate the thermal expansion and contraction of the molten glass delivery conduit assembly 110 in the lateral direction of the molten glass delivery conduit assembly 110 (i.e., in the +/−X directions of the coordinate axes depicted in the figures). In embodiments, the support frame 128 may also be constructed to accommodate the thermal expansion and contraction of the molten glass delivery conduit assembly 110 in the vertical direction of the molten glass delivery conduit assembly 110 (i.e., the +/−Z direction of the coordinate axes depicted in the figures).

For example, in embodiments, the support frame 128 may comprise a plurality of vertical support members (vertical support members 130a, 130b, 130c depicted in FIGS. 3 and 4) and a plurality of horizontal support members 132a, 132b. The vertical support members 130a, 130b, 130c and the horizontal support members 132a, 132b may be formed from a load bearing material such as, for example and without limitation, structural steel or a similar load bearing material. The lower ends of vertical support members 130a, 130b, 130c (i.e. the ends of the vertical support members in the −Z direction of the coordinate axes depicted in the figures) may be coupled to the base plate 124 of the upper carriage 102a with lateral spring elements 134. Similarly, the upper ends of the vertical support members 130a, 130b, 130c (i.e. the ends of the vertical support members in the +Z direction of the coordinate axes depicted in the figures) may be coupled to the horizontal support members 132a, 132b with lateral spring elements 134. The lateral spring elements 134 may be, for example and without limitation, compression springs, disc springs, spring bolts, and/or combinations thereof.

The lateral spring elements 134 may allow for displacement of the vertical support members 130a, 130b, 130c in the +/−X direction of the coordinate axes depicted in the figures (i.e., laterally) to accommodate for the thermal expansion and contraction of a molten glass delivery conduit assembly 110 (not depicted in FIG. 4) positioned within the volume 142 enclosed by the support frame 128 and the base plate 124 of the upper carriage 102a. That is, as the molten glass delivery conduit assembly 110 is heated within the volume 142 enclosed by the support frame 128 and the base plate 124, the molten glass delivery conduit assembly 110 may expand and exert a force on the vertical support members 130a, 130b, 130c in the +/−X direction. The lateral spring elements 134 allow for the displacement of the vertical support members 130a, 130b, 130c in the +/−X direction, thereby accommodating the thermal expansion of the molten glass delivery conduit assembly 110. Similarly, as the molten glass delivery conduit assembly 110 cools within the volume 142 enclosed by the support frame 128 and the base plate 124, the molten glass delivery conduit assembly 110 contracts away from the vertical support members 130a, 130b, 130c. The lateral spring elements 134 may allow for the displacement of the vertical support members 130a, 130b, 130c in the +/−X direction such that the vertical support members 130a, 130b, 130c remain in contact with the molten glass delivery conduit assembly 110, thereby supporting the molten glass delivery conduit assembly 110 as it cools and contracts.

In addition to the lateral spring elements 134, the support frame 128 may also include vertical spring elements 136. Specifically, the upper ends of the vertical support members 130a, 130b, 130c (i.e. the ends of the vertical support members in the +Z direction of the coordinate axes depicted in the figures) may be coupled to the horizontal support members 132a, 132b with vertical spring elements 136. The vertical spring elements 136 may be, for example and without limitation, compression springs, disc springs, spring bolts, and/or combinations thereof.

The vertical spring elements 136 may allow for displacement of the horizontal support members 132a, 132b in the +/−Z direction of the coordinate axes depicted in the figures (i.e., vertically) to accommodate for the thermal expansion and contraction of a molten glass delivery conduit assembly 110 (not depicted in FIG. 4) positioned within the volume 142 enclosed by the support frame 128 and the base plate 124. That is, as the molten glass delivery conduit assembly 110 is heated within the volume 142 enclosed by the support frame 128 and the base plate 124, the molten glass delivery conduit assembly 110 expands and exerts a force on the horizontal support members 132a, 132b in the +Z direction. The vertical spring elements 136 may allow for displacement of the horizontal support members 132a, 132b in the +Z direction, thereby accommodating thermal expansion of the molten glass delivery conduit assembly 110. Similarly, as the molten glass delivery conduit assembly 110 cools within the volume 142 enclosed by the support frame 128 and the base plate 124, the molten glass delivery conduit assembly 110 contracts away from the horizontal support members 132a, 132b. The vertical spring elements 136 may allow for displacement of the horizontal support members 132a, 132b in the −Z direction such that the horizontal support members 132a, 132b remain in contact with the molten glass delivery conduit assembly 110, thereby supporting the molten glass delivery conduit assembly 110 as it cools and contracts.

In embodiments, the support frame 128 of the upper carriage 102a may further comprise vertical support plates (two vertical support plates 138a, 138b are depicted in FIGS. 3 and 4) and/or horizontal support plates (one horizontal support plate 140 is depicted in FIGS. 3 and 4) to provide additional support to a molten glass delivery conduit assembly 110 positioned within the volume 142 enclosed by the support frame 128 and the base plate 124. For example, in embodiments, the support frame 128 may further comprise vertical support plates 138a, 138b disposed within the volume 142 enclosed by the support frame 128 and the base plate 124. The vertical support plate 138a may be coupled to the vertical support members 130a, 130b, such as by welding, mechanical fasteners or the like, such that the vertical support plate 138a is disposed between the vertical support members 130a, 130b and a molten glass delivery conduit assembly 110 positioned in the volume 142 enclosed by the support frame 128 and the base plate 124. Similarly, the vertical support plate 138b may be coupled to the vertical support member 130c, such as by welding, mechanical fasteners, or the like, such that the vertical support plate 138a is disposed between the vertical support member 130c and a molten glass delivery conduit assembly 110 positioned in the volume 142 enclosed by the support frame 128 and the base plate 124. The vertical support plates 138a, 138b may be formed from a load bearing material such as, for example and without limitation, structural steel or a similar load bearing material. The vertical support plates 138a, 138b may allow for the force exerted by the molten glass delivery conduit assembly 110 on the vertical support members 130a, 130b, 130c (and vice-versa) to be uniformly distributed along the longitudinal length of the molten glass delivery conduit assembly 110 (i.e., the length of the molten glass delivery conduit assembly 110 generally in the +/−Y direction of the coordinate axes depicted in the figures) such that the molten glass delivery conduit assembly 110 is uniformly supported by the support frame 128 during thermal expansion and contraction and in between periods of thermal expansion and contraction.

In embodiments, the support frame 128 further comprises a horizontal support plate 140 disposed within the volume 142 enclosed by the support frame 128 and the base plate 124. The horizontal support plate 140 may be coupled to the horizontal support members 132a, 132b, such as by welding, mechanical fasteners or the like, such that the horizontal support plate 140 is disposed between the horizontal support members 132a, 132b and a molten glass delivery conduit assembly 110 positioned in the volume 142 enclosed by the support frame 128 and the base plate 124 (e.g., as depicted in FIG. 6). The horizontal support plate 140 may be formed from a load bearing material such as, for example and without limitation, structural steel or a similar load bearing material. The horizontal support plate 140 may allow for the force exerted by the molten glass delivery conduit assembly 110 on the horizontal support members 132a, 132b (and vice-versa) to be uniformly distributed along the longitudinal length of the molten glass delivery conduit assembly 110 such that the molten glass delivery conduit assembly 110 is uniformly supported by the support frame 128 during thermal expansion and contraction and in between periods of thermal expansion and contraction.

Still referring to FIGS. 3 and 4, in embodiments, the molten glass delivery apparatus 100 may further comprise one or more expansion assist members 144 to assist with translation of the lower carriage 104 along the side lower support rails 118a, 118b of the lower rail system 112. Specifically, during thermal expansion and contraction of a molten glass delivery conduit assembly 110 positioned within the volume 142 enclosed by the support frame 128 and the base plate 124, the longitudinal length of all or part of the molten glass delivery conduit assembly 110 may increase (thermal expansion) or decrease (thermal contraction), causing the lower carriage 104 to translate along the side lower support rails 118a, 118b of the lower rail system 112. Despite the incorporation of a plurality of lower carriage rollers 116a, 116b between the lower carriage 104 and the side lower support rails 118a, 118b, the large mass of the upper carriage 102a, the molten glass delivery conduit assembly 110, and the molten glass flowing through the molten glass delivery conduit assembly 110 may make it difficult to overcome the static inertia of the upper carriage 102a and thereby set the upper carriage 102a in motion on the plurality of lower carriage rollers 116a, 116b. If the static inertia of the upper carriage 102a is not overcome, additional stress may be imparted to the molten glass delivery conduit assembly 110, potentially resulting in damage and/or failure of the molten glass delivery conduit assembly 110. The expansion assist member 144 may assist in overcoming the static inertia of the upper carriage 102a by providing an expansion assist force to the lower carriage 104 in the direction of longitudinal expansion (i.e., expansion in a direction of the longitudinal length of the molten glass delivery conduit assembly 110) when the molten glass delivery conduit assembly 110 is heated.

Specifically, the expansion assist member 144 may comprise a spring member, such as a pneumatic cylinder, a hydraulic cylinder, a compression spring, or the like, which exerts a biasing force in one direction (i.e., the expansion assist member behaves as a single-acting cylinder). In the embodiments described herein, the biasing force may be in the direction of longitudinal expansion of the molten glass delivery conduit assembly 110 (i.e., the +/−Y direction of the coordinate axes depicted in the figures). The expansion assist member 144 may be coupled to the lower carriage 104 with a carriage bracket 146 and to the first side lower support rail 118a with a rail bracket 148 such that the expansion assist member 144 is mechanically grounded to the first side lower support rail 118a. The expansion assist member 144 may apply an expansion assist force to the lower carriage 104 through the carriage bracket in either the + or −Y direction to aid in overcoming the static inertia of the upper carriage 102a and encouraging the translation of the lower carriage 104 as the molten glass delivery conduit assembly 110 is heated and thermally expands.

In embodiments, the molten glass delivery apparatus 100 may further comprise one or more mass compensation members 150 to counteract the mass of the upper carriages 102a, 102b and the molten glass delivery conduit assembly 110 along the side upper support rails 120a, 120b of the upper rail system 106 and thereby prevent unwanted motion of the upper carriages 102a, 102b along the side upper support rails 120a, 120b of the upper rail system 106. Specifically, as noted herein, the side upper support rails 120a, 120b of the upper rail system 106 may be oriented at an elevation angle α relative to horizontal and the plurality of upper carriage rollers 126a, 126b are engaged with the side upper support rails 120a, 120b of the upper rail system 106. Accordingly, without any additional compensation or restraint, the upper carriage 102a will translate down the side upper support rails 120a, 120b due to gravity. Moreover, when components of the upper carriage 102a expand, the expansion may be inhibited by the force of gravity acting on the upper carriage 102a which, in turn, may introduce stress into the components. To prevent this unwanted motion and to mitigate the introduction of stress, the molten glass delivery apparatus 100 may comprise a mass compensation member 150 applying an upward mass compensating force to the upper carriage 102a along the upper rail system 106. It should be appreciated that the molten glass delivery apparatus 100 may comprise a mass compensation member 150 associated with the upper carriage 102b as well.

Specifically, the mass compensation member 150 may comprise a spring member, such as a pneumatic cylinder, a hydraulic cylinder, a compression spring, or the like, which exerts a biasing force in one direction (i.e., the mass compensation member 150 behaves as a single-acting cylinder). In the embodiments described herein, the mass compensation member 150 may be coupled to the upper carriage 102a with a carriage bracket 152 and to the first side upper support rail 120a with a rail bracket 154 such that the mass compensation member 150 is mechanically grounded to the first side upper support rail 120a and the biasing force of the mass compensation member 150 is parallel to the first side upper support rail 120a with a force component in the upward vertical direction (i.e., the +Z direction of the coordinate axes depicted in the figures). The mass compensation member 150 may apply an upward mass compensating force along the upper rail system 106 (specifically along the side upper support rails 120a, 120b) and to the upper carriage 102a through the carriage bracket 152 to prevent motion of the upper carriage 102a down the side upper support rails 120a, 120b due to gravity. In embodiments, a horizontal component of the upward mass compensating force applied by the mass compensation member 150 may be opposite a horizontal component of the expansion assist force applied by the expansion assist member 144. The mass compensation member 150 may also aid in accommodating thermal expansion of a molten glass delivery conduit assembly 110 as the upper carriage 102a is heated by facilitating translation of the upper carriage 102a on the upper rail system 106 against the downward force of gravity acting on the upper carriage 102a.

Referring now to FIG. 7, an embodiment of a molten glass delivery apparatus 100a is depicted. It should be appreciated that the molten glass delivery apparatus 100a is identical to the molten glass delivery apparatus 100 except for the manner in which the upper carriages 102a, 102b are movably coupled to a floor surface. Specifically, rather than the upper carriages 102a, 102b being rollably movable on an upper rail system 106, which is coupled to a lower carriage 104, which is rollably movable on a lower rail system 112, the upper rail system 106 is mechanically grounded to a floor surface 107 and fixed thereto to prohibit movement of the upper rail system 106 in the +/−Y direction of the coordinate axis depicted in the drawings. This eliminates the need for the lower rail system 112. In embodiments, one or more jack assemblies 109 extend between the upper rail system 106 and the floor surface 107. The jack assemblies 109 are secured to the floor surface 107 and are individually adjustable to increase the inclination of the upper rail system 106 relative to the floor surface 107.

Referring now to FIGS. 6 and 8A-8C, FIG. 6 schematically depicts a cross-section of the molten glass delivery apparatus 100 with the molten glass delivery conduit assembly 110 positioned in the volume enclosed by the support frame 128 and the base plate 124; FIG. 8A schematically depicts a cross-section of the molten glass delivery conduit assembly 110 through the X-Z plane of the coordinate axes depicted in the figures; FIG. 8B schematically depicts an exploded view of a portion of the molten glass delivery conduit assembly 110 of FIG. 8A; and FIG. 8C schematically depicts a cross-section of the molten glass delivery conduit assembly 110 through the X-Z plane of the coordinate axes depicted in the figures and comprising a flange 220 for supplying electrical current to the molten glass delivery conduit assembly 110. In embodiments, the molten glass delivery conduit assembly 110 may comprise a cradle assembly 180, a tube assembly 190, and a delivery conduit 200. In embodiments, the molten glass delivery conduit assembly 110 may further comprise at least one flange 220 electrically coupled to the delivery conduit 200. In embodiments, the cradle assembly 180 and the tube assembly 190 may be constructed to prevent the cradle assembly 180 and the tube assembly 190 from sliding relative to one another as the molten glass delivery conduit assembly 110 is heated and cools. However, the delivery conduit 200 is free to slide relative to the cradle assembly 180 and the tube assembly 190 as the molten glass delivery conduit assembly 110 is heated and cools.

Specifically referring to FIGS. 8A and 8B, the molten glass delivery conduit assembly 110 may include a delivery conduit 200 through which molten glass flows. In embodiments, the delivery conduit 200 may be formed from refractory metal such as, for example and without limitation, platinum, molybdenum, palladium, rhodium, iridium, rhenium, tantalum, titanium, tungsten, alloys thereof, and/or combinations thereof, to be able to withstand the high temperatures and corrosive nature of the molten glass flowing there through. While the figures depict the delivery conduit 200 as being circular in cross-section, other cross-sections are contemplated and possible, including, without limitation delivery conduits that are elliptical in cross-section, oblong in cross-section, oval in cross-section, and the like. In embodiments, heater windings 201 may be wrapped around the delivery conduit 200 to facilitate heating the delivery conduit 200 and/or to supplement heating of the delivery conduit 200.

In embodiments, the delivery conduit 200 may be positioned in a tube assembly 190 such that the delivery conduit 200 and the tube assembly 190 both extend in the longitudinal direction of the molten glass delivery conduit assembly 110. The tube assembly 190 may be constructed of refractory ceramic material that insulates the delivery conduit 200, and the molten glass flowing there through, and minimizes temperature variations in the radial direction of the molten glass delivery conduit assembly 110 (i.e., temperature variations in directions perpendicular to the +/−Y direction of the coordinate axes depicted in the figures). The tube assembly 190 may be formed from, for example and without limitation, alumina, zirconia, stabilized zirconia, and/or combinations thereof. In embodiments, the tube assembly 190 may be formed from a plurality of discrete portions that are assembled around the delivery conduit 200. For example, in embodiments, the tube assembly 190 may be constructed from a lower tube portion 192 and an upper tube portion 194, as depicted in FIG. 8B. In embodiments, the lower tube portion 192 and/or the upper tube portion 194 may be constructed from a plurality of discrete segments. For example, as depicted in FIG. 8B, the upper tube portion 194 may be constructed of a plurality of tube segments 196a, 196b, 196c extending in the longitudinal direction of the molten glass delivery conduit assembly 110 and arranged in an arch around at least a portion of the delivery conduit 200. While FIG. 8B depicts the upper tube portion 194 as being constructed from a plurality of tube segments 196a, 196b, 196c, other embodiments are contemplated and possible, such as embodiments where the lower tube portion 192 is constructed from a plurality of tube segments and embodiments where both the lower tube portion 192 and the upper tube portion 194 are constructed from a plurality of tube segments.

In the embodiments described herein, the delivery conduit 200 is not adhered or attached to the tube assembly 190 and, as such, the delivery conduit 200 is free to slide with respect to the tube assembly 190. As a result, when the molten glass delivery conduit assembly 110 is heated and cooled, the delivery conduit 200 is free to thermally expand and contract relative to the tube assembly 190 thereby avoiding the introduction of additional stress into the delivery conduit 200.

Still referring to FIGS. 8A and 8B, the delivery conduit 200 and the tube assembly 190 may be positioned in the cradle assembly 180, which includes a lower cradle block 182 and an upper cradle block 184, such that the delivery conduit 200, the tube assembly 190, and the cradle assembly 180 extend in the longitudinal direction of the molten glass delivery conduit assembly 110. The cradle assembly 180 may be constructed of refractory ceramic material that insulates the tube assembly 190, the delivery conduit 200, and the molten glass flowing there through, and minimizes temperature variations in the radial direction of the molten glass delivery conduit assembly 110. The cradle assembly 180 may be formed from, for example and without limitation, alumina, zirconia, stabilized zirconia, and/or combinations thereof. In embodiments, the cradle assembly 180 may be formed from a plurality of discrete portions that are assembled around the tube assembly 190. For example, in embodiments, the cradle assembly 180 may be constructed from a lower tube portion 192 and an upper tube portion 194, as depicted in FIG. 8B.

Referring now to FIGS. 6 and 8A, an insulating refractory block 202 and/or refractory board may be positioned around the cradle assembly 180 to provide further insulation to the delivery conduit 200, the tube assembly 190, the cradle assembly 180, and the molten glass flowing there through. In embodiments, the refractory block 202 may be formed from, for example and without limitation, alumina, zirconia, stabilized zirconia, and/or combinations thereof.

As noted herein, the components and construction of individual upper carriages 102a, 102b of the molten glass delivery apparatus 100 may generally be the same. However, in embodiments, the refractory ceramic materials used in, for example, the cradle assembly 180 and the tube assembly 190, may be different in each of the upper carriages 102a, 102b. Specifically, the refractory ceramic materials may be selected to provide the desired amount of insulation or, conversely, the desired amount of heat conduction, in a particular upper carriage 102a, 102b of the molten glass delivery apparatus 100 regardless of the refractory ceramic materials used in another upper carriage of the molten glass delivery apparatus 100.

In embodiments, the cradle assembly 180 and the tube assembly 190 may be joined to prevent relative movement between the cradle assembly 180 and the tube assembly 190 when the molten glass delivery conduit assembly 110 is heated and cooled. This allows the molten glass delivery conduit assembly 110 and the upper carriage to be supported as a single, unitary solid by, for example, the mass compensation member 150. Similarly, in embodiments, the cradle assembly 180 and refractory block 202 are joined to prevent relative movement between the cradle assembly 180 and the refractory block 202 when the molten glass delivery conduit assembly 110 is heated and cooled.

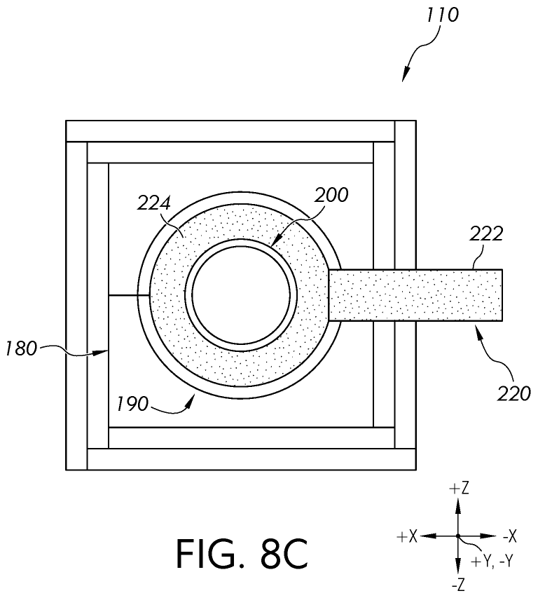

Referring now to FIG. 9, in embodiments, the lower cradle block 182 and the upper cradle block 184 of the cradle assembly 180 of the upper carriage 102b may include a projection 185 extending in the longitudinal direction of the molten glass delivery conduit assembly 110 for engaging a groove 187 formed in the adjacent upper carriage 102a. More particularly, the groove 187 of the upper carriage 102a similarly extends in the longitudinal direction of the molten glass delivery conduit assembly 110 and is formed in the lower cradle block 182 and the upper cradle block 184 of the cradle assembly of the upper carriage 102a. It should be appreciated that engagement of the projection 185 and the groove 187 limit radial movement of the upper carriages 102a, 102b relative to one another during expansion. Here, radial movement may include movement of the upper carriages 102a, 102b in either or both of a vertical direction (in the +/−Z direction of the coordinate axes depicted in the figures) or a lateral direction (in the +/−X direction of the coordinate axes depicted in the figures). As shown in FIG. 8A, the projection 185 encircles the lower tube portion 192 and the upper tube portion 194 of the upper carriage 102b. Similarly, the groove 187 encircles the lower tube portion 192 and the upper tube portion 194 of the upper carriage 102a. It should be appreciated that in embodiments in which the molten glass delivery apparatus 100 includes more than two upper carriages, each upper carriage may include a projection 185 provided at a first end of the upper carriage and a groove 187 formed at an opposite second end of the upper carriage such that an adjacent upper carriage may be joined at each end.

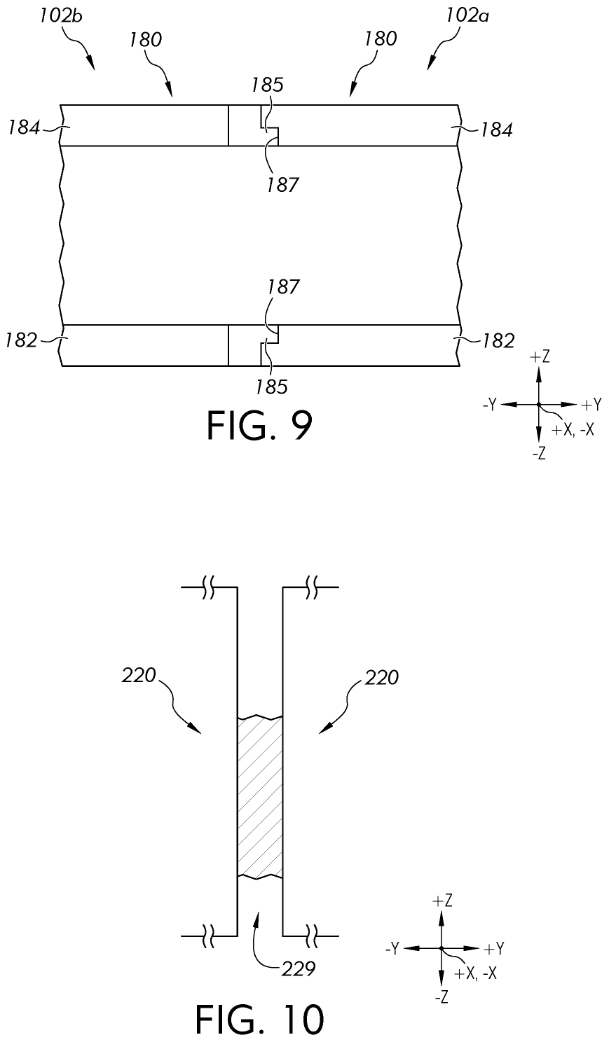

Referring now to FIGS. 2 and 8C-10, in embodiments, each upper carriage 102a, 102b of the molten glass delivery apparatus 100 may comprise a separate delivery conduit 200. In these embodiments, the molten glass delivery conduit assembly 110 may comprise flanges 220 positioned at both ends of the delivery conduit 200. The flanges 220 facilitate the formation of glass seals between, for example, the molten glass delivery conduit assemblies 110 of individual upper carriages 102a, 102b of the molten glass delivery apparatus 100. For example, the molten glass delivery apparatus 100 may comprise a plurality of upper carriages arranged in series, as noted herein. Molten glass flows through the upper carriages in a serial fashion (i.e., through one upper carriage before flowing through the next upper carriage). Conventional seals are not used between adjacent upper carriages 102a, 102b of the molten glass delivery apparatus 100 due to the relatively high temperature and corrosive nature of the molten glass, together with the relatively large thermal expansion of components of the upper carriages. Instead, molten glass is allowed to leak between the adjacent upper carriages 102a, 102b. As the molten glass cools and solidifies, a glass seal is formed between the adjacent upper carriages 102a, 102b. In the embodiment depicted in FIG. 10, molten glass leaks between the flanges 220 of adjacent upper carriages 102a, 102b and solidifies between the flanges 220, thereby forming a glass seal 229.

In embodiments, the flanges 220 may be electrically conductive to facilitate heating the delivery conduit 200 by flowing current through the flanges 220 and, in turn, the delivery conduit 200. In these embodiments, the flanges 220 circumscribe the delivery conduit 200 and are maintained in electrical contact with an exterior surface of the delivery conduit 200. Electrical current is passed through the flanges 220 and into the delivery conduit 200 to heat the delivery conduit 200 and the molten glass within the delivery conduit 200. In various embodiments, the flanges 220 circumscribe at least a portion of the delivery conduit 200 and can be positioned at longitudinal ends of the molten glass delivery conduit assembly 110. Because of the electrical resistance of the delivery conduit 200, the electrical current heats the delivery conduit 200 directly, thereby heating the molten glass inside the delivery conduit 200.

Referring specifically to FIG. 8C by way of example, the flanges 220 may comprise a bus portion 222 and a distribution portion 224 extending around the delivery conduit 200. However, other embodiments are contemplated and possible. The flanges 220 may facilitate the introduction of electrical current into the delivery conduit 200 for targeted and/or high efficiency heating of the molten glass, and may be selected based on at least the magnitude of the electrical current that is being passed to the delivery conduit 200 and accessibility of the bus portion 222 for connection with a current source.

In the embodiments described herein, the flanges 220 may be made from a low resistance metal, for example, a transition metal such as, without limitation, electrical grade nickel 600/601 and/or a high temperature refractory metal such as, for example and without limitation, platinum or alloys thereof, that are suitable for use at the elevated temperatures experienced in glass manufacturing. In various embodiments, the flanges 220 may be cooled, for example, by air-cooling or water-cooling. In various embodiments, cooling fluid can be directed through a cooling tube (not depicted) coupled to and extending around the flanges 220. In other embodiments, cooling fluid can be used to cool selected portions of the flanges 220.

While FIGS. 2, 8C, and 9 depict each upper carriage 102a, 102b of the molten glass delivery apparatus 100 as comprising a separate delivery conduit 200, other embodiments are contemplated and possible. For example, in other embodiments (not depicted), the molten glass delivery apparatus 100 may comprise a single delivery conduit 200 that extends through and between a plurality of upper carriages 102a, 102b. In these embodiments, the flanges 220 may be located at opposite ends of the single delivery conduit 200. In some embodiments, the single delivery conduit 200 may further include additional flanges positioned on the conduit between adjacent upper carriages.

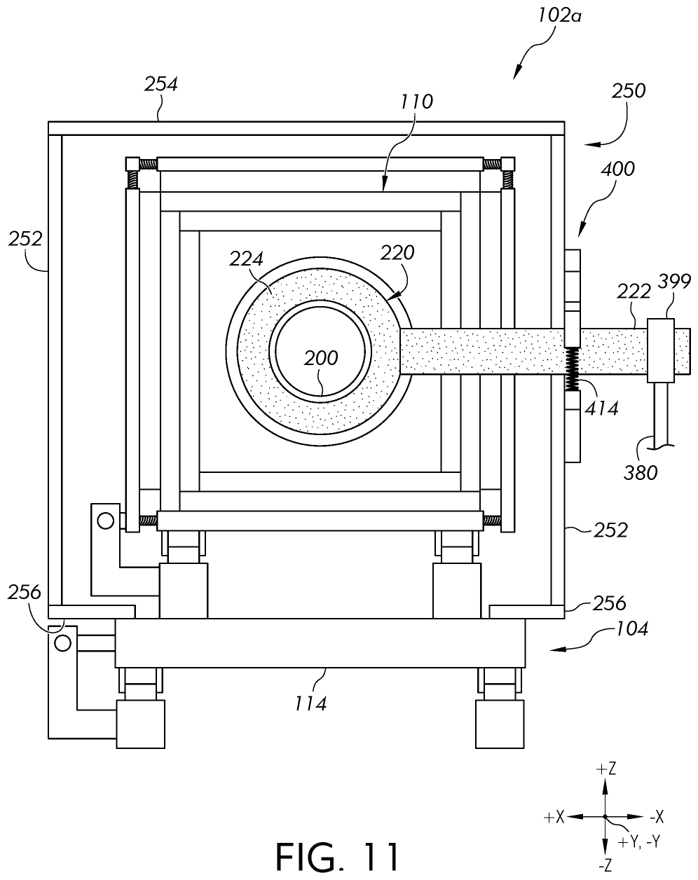

Referring now to FIG. 11, in embodiments, the molten glass delivery apparatus 100 may further comprise an exterior support frame 250 to facilitate coupling of the flange 220 to a translatable support 400, discussed herein. The exterior support frame 250 may comprise exterior vertical support members 252 joined to exterior horizontal support members 254 (one depicted in FIG. 11) by welding, mechanical fasteners, or the like. The exterior support frame 250 may be coupled to the lower carriage frame 114 of the lower carriage 104 with, for example and without limitation, brackets 256 such that the exterior support frame 250 is translatable with the lower carriage 104. In embodiments, the flanges 220 are coupled to the exterior support frame 250 to accommodate translation of the flanges 220 upon thermal expansion and contraction of the flanges and other components of the molten glass delivery conduit assembly 110. For example, a translatable support 400 may be coupled to the exterior vertical support member 252 of the exterior support frame 250 to support the flanges 220.

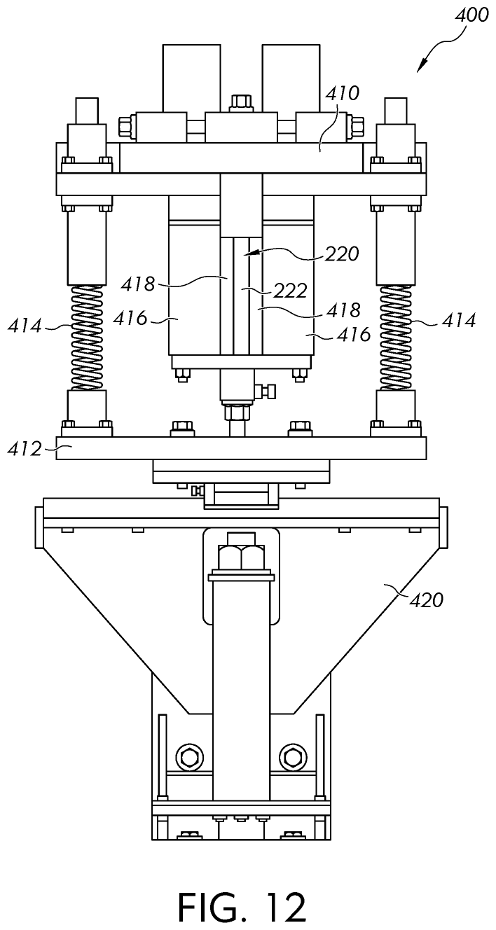

Referring now to FIG. 12, the translatable support 400 is depicted comprising an upper support frame 410, a lower support frame 412, and a pair of support dampers 414 extending between the upper support frame 410 and the lower support frame 412. A pair of flange supports 416 extend from the upper support frame 410 between the support dampers 414 in a direction toward the lower support frame 412. The bus portion 222 of the flange 220 is secured between the flange supports 416 and water-cooled members 418 are provided on opposite sides of the flange 220 between the flange 220 and the flange supports 416. The water-cooled members 418 prevent overheating of the bus portion 222 of the flange. A support mount 420 may be coupled to the lower support frame 412 and be fixed to the exterior vertical support member 252 of the exterior support frame 250, such as by welding, mechanical fasteners, or the like, to secure the translatable support 400 to the exterior support frame 250. The support dampers 414 permit the upper support frame 410 to move in a vertical direction relative to the lower support frame 412 and accommodate for thermal expansion and contraction of the flange 220 and other components of the molten glass delivery conduit assembly 110. For example, as the delivery conduit 200 is heated or cools, the delivery conduit 200 thermally expands or contracts. Thermal expansion and contraction of the delivery conduit changes the vertical position of the flange 220. The support dampers 414 maintain support of the flange 220 during expansion and contraction while minimizing stress imparted to the delivery conduit by the weight of the flange 220.

While not depicted in the figures, in embodiments, the exterior support frame 250 may further comprise panels attached the exterior support frame 250 thereby forming a capsule around the molten glass delivery conduit assembly 110. Encapsulation of the molten glass delivery conduit assembly 110 allows for the atmosphere immediately surrounding the molten glass delivery conduit assembly 110 to be controlled, thereby preventing, for example, hydrogen permeation through platinum components of the molten glass delivery conduit assembly 110.

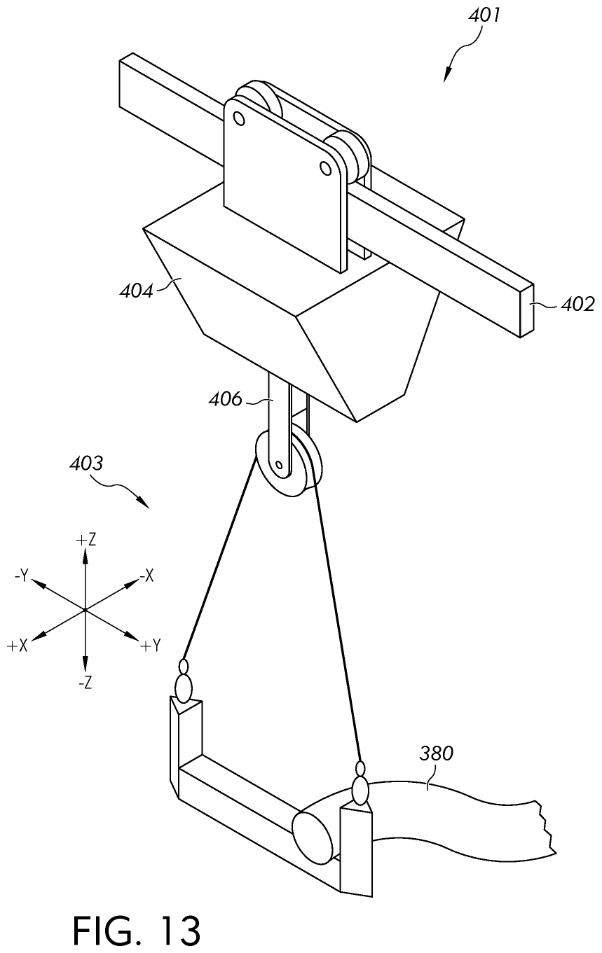

Referring now to FIGS. 11 and 13, in embodiments, the bus portions 222 of the flanges 220 may be coupled to a power source (not depicted) with clamps 399 and power delivery cables 380. The delivery cables 380 may have a relatively large mass to accommodate delivery of the electrical power required for heating the delivery conduit 200 without melting the delivery cables 380. A portion of the weight of the distribution cables may be transmitted to the delivery conduit 200 through the flanges 220, thereby introducing additional stress to the delivery conduit 200. In embodiments, to offset the weight of the delivery cables 380 imparted to the delivery conduit (and thereby reduce the stress imparted to the delivery conduit 200), the delivery cables may be supported by an overhead support structure 401 as depicted in FIG. 13. The overhead support structure 401 may include a rail 402 suspend over the upper carriage 102a. The overhead support structure 401 may further include hangers 403 that extend from the rail 402. The hangers 403 may be coupled to the delivery cables 380 such that the delivery cables 380 are suspended from the rail 402. The hangers 403 support the weight of the delivery cables 380, such that stress imparted on the delivery conduit 200 by the weight of the delivery cables 380 is minimized. In embodiments, the hangers 403 may be supported by trolleys 404 that are translatable along the rail 402. The trolleys 404 may allow the hangers 403 to translate while supporting the delivery cables 380 thereby minimizing misalignment of the delivery cables 380 with the flanges 220 to which the delivery cables 380 are coupled as the delivery conduit 200 expands and contracts. For example, as the upper carriage 102a is heated and cools, the delivery conduit 200 expands and contracts, which may cause the flanges 220 to translate in the longitudinal direction. The trolleys 404 may allow the delivery cables 380 to translate with the flanges 220 such that the hangers 403 support the delivery cables 380 as the position of the flanges 220 change, thereby reducing the stress imparted to the delivery conduit 200 by the delivery cables 380.

In embodiments, the hangers 403 may include spring supports 406. The spring supports 406 may have a spring constant that allows the spring support 406 to provide continuous vertical support to the delivery cables 380 when the delivery cables 380 are displaced vertically (i.e., in the +/−Z direction of the coordinate axes depicted in the figures). For example, when the delivery conduit 200 is heated and cools, the delivery conduit 200 thermally expands both radially (i.e., in directions perpendicular to the +/−Y directions of the coordinate axes depicted in the figures) and longitudinally (i.e., in the +/−Y directions of the coordinate axes depicted in the figures). Radial expansion and contraction of the delivery conduit 200 changes the vertical elevation of the flange 220. To minimize the stress imparted onto the delivery conduit 200 by the weight of the flanges 220, the spring supports 406 may be selected and fitted such that a vertical force is applied to the flanges 220, even when the positions of the flanges 220 are shifted vertically. The spring supports 406, therefore, support the delivery cables 380 irrespective of the position of the delivery cables 380 relative to the overhead support structure 401. The hangers 403, therefore, may minimize the introduction of stress to components of the upper carriage 102a, for example, the delivery conduit 200, as the upper carriage 102a is heated and cools.

Operation of the molten glass delivery apparatus 100 with the glass manufacturing apparatus 10 will now be described in further detail with specific reference to FIGS. 1-5. Reference will be made to use of the molten glass delivery apparatus 100 in place of the connecting tube 50 connecting the fining system 13 with the mixing vessel 14.

Initially, the upper carriages 102a, 102b may be positioned between the fining system 13 and the mixing vessel 14 on the upper rail system 106, the lower carriage 104, and the lower rail system 112. The delivery conduits 200 of each upper carriage 102a, 102b may be aligned with one another, with the outlet of the fining system 13 and the inlet of the mixing vessel 14 to facilitate the flow of molten glass 16 from the fining system 13 to the mixing vessel 14 through the upper carriages 102a, 102b of the molten glass delivery apparatus 100. Current may then introduced into the flanges 220 (and/or into the heater windings 201 (FIG. 8B) to pre-heat the delivery conduits 200 prior to the delivery conduits 200 receiving a flow of molten glass 16 from the fining system 13.

Thereafter, molten glass 16 may be directed through the delivery conduits 200 of the upper carriages 102a, 102b and into the mixing vessel 14 while the delivery conduits 200 are heated through the flanges 220 and/or the heater windings 201. As the temperatures of the upper carriages 102a, 102b increase, components of the upper carriages 102a, 102b may thermally expand vertically, laterally, and longitudinally due to their respective coefficients of thermal expansion, as described herein. For example, as the delivery conduits 200 expand longitudinally, the upper carriages 102a, 102b may exert a force against one another and/or against the fining system 13 and the mixing vessel 14. These forces may cause the displacement of the lower carriage 104 along the lower rail system 112 and the upper carriages 102a, 102b along the upper rail system 106, thereby accommodating the longitudinal thermal expansion of the upper carriages 102a, 102b of the molten glass delivery apparatus 100 in the longitudinal direction without introducing static stresses into the component parts of the upper carriages 102a, 102b, such as the delivery conduits 200 or the like. Displacement of the lower carriages 104 may be assisted by, for example, the expansion assist members 144 and the mass compensation members 150.

As described herein, heating the components of the glass manufacturing apparatus 10 to operating temperatures increases the dimensional size of the components according to their respective coefficients of thermal expansion. Accordingly, the fining system 13 and the mixing vessel 14 may also expand in any direction, such as vertically, laterally, and/or longitudinally, and the molten glass delivery apparatus 100 must accommodate for such expansion to ensure that cracks do not form in the molten glass delivery apparatus 100. The vertical biasing members 122a, 122b, 122c assist in accommodating for this expansion and allow the molten glass delivery apparatus 100 to maintain a sealed connection with the fining system 13 and the mixing vessel 14.

Thermal expansion of components of the upper carriages 102a, 102b in the lateral direction (+/−X direction of the coordinate axes depicted in the figures) may be accommodated by the lateral spring elements 134 and the vertical spring elements 136 of the support frames 128. Specifically, as the components of the molten glass delivery conduit assemblies 110 thermally expand radially and press against the vertical support members 130a, 130b, 130c and the horizontal support members 132a, 132b, the lateral spring elements 134 and the vertical spring elements 136 allow for displacement of the vertical support members 130a, 130b, 130c and the horizontal support members 132a, 132b, respectively. This accommodates for the radial thermal expansion of the molten glass delivery conduit assemblies 110 and mitigating the introduction of stress in the delivery conduits 200. Additionally, stress on adjacent upper carriages 102 may be minimized by the interlocking of cradle assembles 180, as described herein. Specifically, the cradle assembly 180 of each upper carriage 102 are interlocked with one another to reduce the level of stress imparted on adjacent upper carriages 102 while maintaining a fluid tight seal between cradle assemblies 180.

Referring to FIGS. 2 and 11-13, the overhead support structure 401 and the translatable support 400 of the upper carriages 102a, 102b accommodate displacement of the flanges 220 of the upper carriages 102a, 102b as the molten glass delivery apparatus 100 is heated. Specifically, the support dampers 414 of the translatable supports 400 accommodate displacement of the flanges 220 in the vertical direction by allowing the upper support frame 410 from the lower support frame 412, thereby mitigating the introduction of stress to the delivery conduits 200 through the flanges 220. Simultaneously, the spring supports 406 accommodate vertical displacement of the flanges 220 and attached delivery cables 380 by retracting in the upwards vertical direction, reducing the weight of the delivery cables 380 incident on the delivery conduits 200 through the flanges 220 and mitigating the introduction of stress into the delivery conduits 200.

The molten glass delivery apparatuses described herein may be used to reduce or mitigate stress in components of the molten glass delivery apparatuses, thereby prolonging the service life of the molten glass delivery apparatuses, increasing production yields, and reducing operating and maintenance costs of the glass manufacturing apparatuses. For example, the molten glass delivery apparatuses described can reduce stresses caused by thermal expansion of components of the apparatuses by accommodating for the thermal expansion of components of the apparatuses. By accommodating for thermal expansion of the components, higher operating temperatures may be achieved, which, in turn, allows for greater flow rates of molten glass (i.e., an increase in the mass of molten glass per hour) through the apparatuses, thereby increasing production output while simultaneously reducing the risk of damage or failure due to stress.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A glass manufacturing apparatus comprising a molten glass delivery apparatus, the molten glass delivery apparatus comprising:
a lower carriage;
an upper rail system supported on the lower carriage, the upper rail system comprising a first side upper support rail and a second side upper support rail, the first side support rail and the second side support rail oriented at an elevation angle α greater than 0 degrees relative to horizontal; and
a plurality of upper carriages supported on the upper rail system, each of the plurality of upper carriages comprising:
a base plate oriented at an elevation angle β greater than 0 degrees relative to horizontal;
a first side upper roller coupled to the base plate and engaged with the first side upper support rail; and
a second side upper roller coupled to the base plate and engaged with the second side upper support rail, wherein:
one of the first side upper roller and the first side upper support rail comprises a rolling surface including a groove engaged with a tongue of the other of the first side upper roller and the first side upper support rail; or
one of the second side upper roller and the second side upper support rail comprises a rolling surface including a groove engaged with a tongue of the other of the first side upper roller and the first side upper support rail.

2. The glass manufacturing apparatus of claim 1, wherein the elevation angle α is equal to the elevation angle β.

3. The glass manufacturing apparatus of claim 1, further comprising a vertical biasing member extending between the lower carriage and the upper rail system and permitting the upper rail system to move in a vertical direction relative to the lower carriage.

4. The glass manufacturing apparatus of claim 1, further comprising a lower rail system comprising a first side lower support rail and a second side lower support rail, the lower carriage supported on the lower rail system.

5. The glass manufacturing apparatus of claim 4, wherein the lower carriage is fixed to the lower rail system.

6. The glass manufacturing apparatus of claim 4, wherein the lower carriage comprises a first side lower roller and a second side lower roller.

7. The glass manufacturing apparatus of claim 6, wherein the first side lower roller engages the first side lower support rail and the second side lower roller engages the first side lower support rail.

8. The glass manufacturing apparatus of claim 6, wherein:
one of the first side upper roller and the first side upper support rail comprises a rolling surface including a groove engaged with a tongue of the other of the first side upper roller and the first side upper support rail; or
one of the second side upper roller and the second side upper support rail comprises a rolling surface including a groove engaged with a tongue of the other of the first side upper roller and the first side upper support rail.

9. The glass manufacturing apparatus of claim 1, further comprising an expansion assist member coupled to the lower carriage, the expansion assist member applying an expansion assist force to the lower carriage.

10. The glass manufacturing apparatus of claim 1, further comprising a support frame coupled to the base plate of each upper carriage, the support frame comprising:
vertical support members coupled to the base plate with lateral spring elements such that the vertical support members are displaceable in a lateral direction relative to the base plate; and
horizontal support members coupled to the vertical support members with vertical spring elements and lateral spring elements such that the horizontal support members are displaceable in a vertical direction relative to the vertical support members and the vertical support members are displaceable in the lateral direction relative to the horizontal support members.

11. The glass manufacturing apparatus of claim 1, further comprising:
a lower locating feature provided on the lower carriage; and
an upper locating feature provided on the upper rail system,
wherein, when the upper rail system is supported on the lower carriage, the lower locating feature aligns with the upper locating feature in a vertical direction relative to each upper carriage.

12. The glass manufacturing apparatus of claim 1, wherein each upper carriage of the plurality of upper carriages further comprises a molten glass delivery conduit assembly supported on the upper carriage, the molten glass delivery conduit assembly comprising:
a cradle assembly comprising an upper cradle block formed from refractory ceramic material and a lower cradle block formed from refractory ceramic material;
a tube assembly positioned in the cradle assembly and extending in a longitudinal direction of the molten glass delivery conduit assembly, the tube assembly comprising an upper tube portion formed from refractory ceramic material and a lower tube portion formed from refractory ceramic material; and
a delivery conduit positioned in the tube assembly and extending in the longitudinal direction, the delivery conduit formed from refractory metal.

13. The glass manufacturing apparatus of claim 12, wherein the upper cradle block and the lower cradle block of a first upper carriage of the plurality of upper carriages interlocks with the upper cradle block and the lower cradle block of a second upper carriage of the plurality of upper carriages, the first upper carriage being adjacent the second upper carriage.

14. The glass manufacturing apparatus of claim 13, wherein:
the upper cradle block and the lower cradle block of the first upper carriage each comprises a projection extending in the longitudinal direction of the molten glass delivery conduit assembly;
the upper cradle block and the lower cradle block of the second upper carriage each comprises a groove formed in the longitudinal direction of the molten glass delivery conduit assembly; and
the projection of the upper cradle block and the lower cradle block of the first upper carriage is engaged with the groove formed in the upper cradle block and the lower cradle block of the second upper carriage.

15. The glass manufacturing apparatus of claim 12, further comprising a flange coupled to the delivery conduit.

16. The glass manufacturing apparatus of claim 15, further comprising a translatable support coupled to the flange and a spring element applying a force to the flange in a vertical direction.

17. A glass manufacturing apparatus comprising a plurality of upper carriages, each upper carriage of the plurality of upper carriages comprising a molten glass delivery conduit assembly comprising:
a cradle assembly comprising an upper cradle block formed from refractory ceramic material and a lower cradle block formed from refractory ceramic material;
a tube assembly positioned in the cradle assembly and extending in a longitudinal direction of the molten glass delivery conduit assembly, the tube assembly comprising an upper tube portion formed from refractory ceramic material and a lower tube portion formed from refractory ceramic material; and
a delivery conduit positioned in the tube assembly and extending in the longitudinal direction, the delivery conduit formed from refractory metal,
wherein the upper cradle block and the lower cradle block of a first upper carriage of the plurality of upper carriages interlocks with the upper cradle block and the lower cradle block of a second upper carriage of the plurality of upper carriages, the first upper carriage being adjacent the second upper carriage.

18. The glass manufacturing apparatus of claim 17, wherein:
the upper cradle block and the lower cradle block of the first upper carriage each comprises a projection extending in the longitudinal direction of the molten glass delivery conduit assembly;
the upper cradle block and the lower cradle block of the second upper carriage each comprises a groove formed in the longitudinal direction of the molten glass delivery conduit assembly; and
the projection of the upper cradle block and the lower cradle block of the first upper carriage is engaged with the groove formed in the upper cradle block and the lower cradle block of the second upper carriage.

19. The glass manufacturing apparatus of claim 17, further comprising a refractory block positioned around the cradle assembly, the refractory block formed from refractory ceramic material.

20. (canceled)

21. (canceled)

22. The glass manufacturing apparatus of claim 17, further comprising:
a lower carriage; and
an upper rail system supported on the lower carriage, the upper rail system comprising a first side upper support rail and a second side upper support rail, the first side upper support rail and the second side upper support rail oriented at an elevation angle α greater than 0 degrees relative to horizontal, wherein
each upper carriage of the plurality of upper carriages comprises:
a base plate oriented at an elevation angle β greater than 0 degrees relative to horizontal;
a first side upper roller coupled to the base plate and engaged with the first side upper support rail; and
a second side upper roller coupled to the base plate and engaged with the second side upper support rail.

23. (canceled)
